(19) United States
(12) Patent Application Publication
(10) Pub. No.: US 2024/0278358 A1
(43) Pub. Date: Aug. 22, 2024

(54) ALUMINUM ALLOYS FOR BRAZABLE CASTING

(71) Applicant: Tesla, Inc., Austin, TX (US)

(72) Inventors: Grant Pattinson, Mountain View, CA (US); Quinlin Hamill, Cupertino, CA (US); Sivanesh Palanivel, Sunnyvale, CA (US); Ricardo Komai, San Jose, CA (US); Jason Robert Stucki, Livermore, CA (US); John David Calderone, San Jose, CA (US); Trevor Clark, Austin, TX (US); Jiajie Chen, Austin, TX (US)

(21) Appl. No.: 18/577,980

(22) PCT Filed: Jul. 22, 2022
(86) PCT No.: PCT/US2022/038041

§ 371 Date: Jan. 9, 2024

Related U.S. Application Data
(60) Provisional application No. 63/203,476, filed on Jul. 23, 2021.

(51) Int. Cl. B23K 35/28; B23K 103/10; C22C 21/00

(52) U.S. Cl. CPC B23K 35/286; C22C 21/00; B23K 2103/10

(57) ABSTRACT

Provided herein are aluminum alloy compositions having high conductivity. Low conductivity parent materials are also described.

### INCORPORATION BY REFERENCE TO ANY PRIORITY APPLICATIONS

This patent application claims the benefit of U.S. Provisional Patent Application Ser. No. 63/203,476, filed Jul. 23, 2021, which is hereby incorporated by reference herein in its entirety.

### BACKGROUND

Generally described, brazing is a metal-joining process in which two or more metal items are joined together by melting and flowing a filler metal into the joint. Typically, the brazing process attempts to avoid melting the joined metal items, with the filler metal having a lower melting point than the adjoining metal. The filler metal flows into the gap between close-fitting parts by capillary action. The filler metal is brought slightly above its melting temperature while protected by a suitable atmosphere. The liquid filler material then flows over the base metal and is then cooled to join the two metal pieces together.

In the context of aluminum pieces being joined, utilization of brazing can mitigate leakage in fluid channels between the pieces and facilitate high operating temperature joints compared to adhesive bonds, small detailed parts with complex joints, large contact areas for strong joints and electrical connectivity between the metal pieces. Aluminum is generally characterized as having a low melting point, coherent and highly stable oxide, high thermal conductivity, high thermal expansion and low density. Accordingly, aluminum pieces are typically brazed with some aluminum based filler alloy characterized by a lower melting point to allow for the brazing process.

### BRIEF DESCRIPTION OF THE DRAWINGS

FIG. 1 is an illustrative graph of high thermal conductivity parent materials for cast alloy systems.

FIG. 2 is a chart of suitable low conductivity parent materials with a eutectic/peritectic temperature above 600° C.

### DETAILED DESCRIPTION

The present invention relates to aluminum alloys. More specifically, the present invention relates to aluminum alloys with relatively high strengths, good castability and improved brazing for high-performance applications including automobile parts. One or more aspects of the present application relates to embodiments in which alloys exhibit low thermal conductivity. One or more aspects of the present application can further relate other embodiments in which alloys exhibit high thermal conductivity. Illustratively, the alloys correspond to aluminum alloys. The present disclosure may be understood by reference to the following detailed description, taken in conjunction with the drawings as described below. It is noted that, for purposes of illustrative clarity, certain elements in various drawings may not be drawn to scale, may be represented schematically or conceptually, or otherwise may not correspond exactly to certain physical configurations of embodiments.

Embodiments relate to aluminum alloys useful for creating products. Aluminum castings generally have low melting points similar to the melting points of the filler materials that are used for brazing. Accordingly brazing aluminum castings is extremely difficult or impossible with conventional brazing techniques as the parent material often undergoes melting or erosion. For example, in some embodiments, an aluminum parent material can be brazed with aluminum braze filler material. However, most braze filler materials are from the same low melting systems as the most common casting alloys (Al—Si or Al—Mg). This means that most aluminum castings are not considered brazeable due to the parent material melting during the brazing process.

In the context of vehicles and vehicle manufacturing, by way of example, in certain HVAC applications where hot and cold lines are close to each other, thermal conductivity is not desired as it can cause parasitic thermal losses to the system. Accordingly, if such HVAC components are to be cast then the HVAC components should be comprised of an alloy/material with poor conductivity, excellent castability and with capabilities for exhibiting good brazeablility. Some materials, such as the alloy disclosed in U.S. Patent Application Publication No. 2019/0127824, entitled CASTING ALUMINUM ALLOYS FOR HIGH-PERFORMANCE APPLICATIONS, have good castability and also exhibit excellent conductivity. U.S. Patent Application Publication No. 2019/0127824 is incorporated by reference herein. In another example, materials like aluminum alloys, referred to as 6063 (magnesium and silicon) are commonly used in manufacturing, but do not exhibit optimal conductivity or castability. Other applications for vehicles that may be applicable with brazed aluminum pieces for high conductivity applications in vehicles can include busbars, heat sinks/cold plates and other plumbing or pressure vessels.

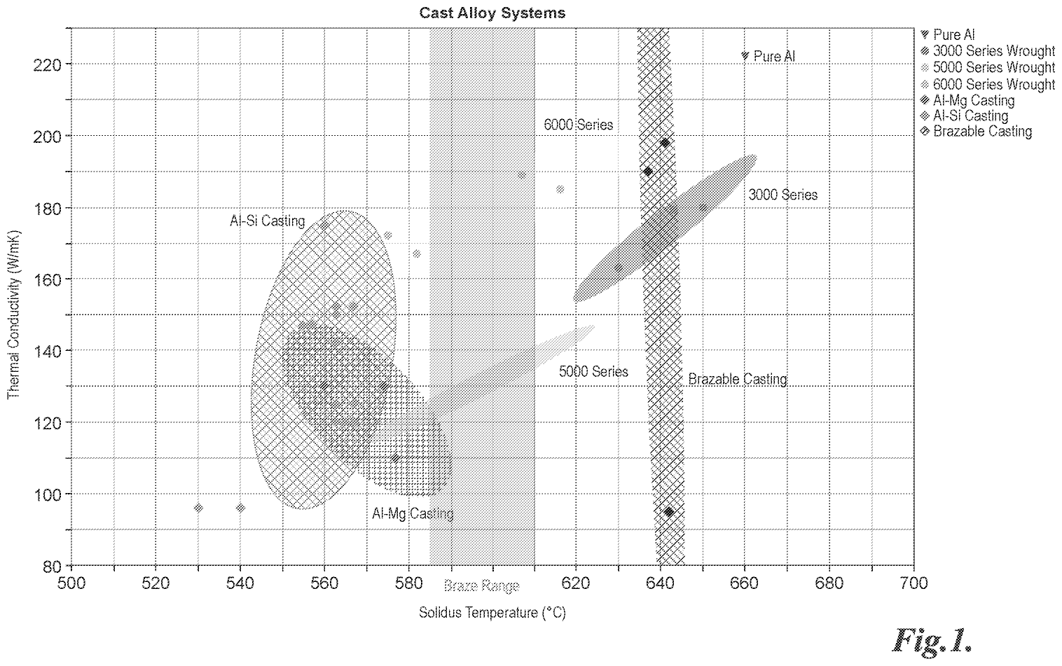

Current approaches for brazing filler materials allow for brazing of conventional aluminum castings, however these materials tend to have availability in limited geometric forms. As discussed previously, many typical brazing materials are not well suited for use in conventional high volume brazing processes with aluminum castings as the parent material will have similar or melting points as the typical brazing materials. FIG. 1 illustrates a plot of thermal conductivity to solidus temperature for a plurality of alloy systems, such as cast alloys and wrought alloys. In one aspect illustrated in FIG. 1, a range of temperatures used for brazing, approximately in the range of 585 degrees Celsius to 610 degrees Celsius is illustrated to identify alloy systems having solidus temperatures below the braze range (e.g., Al—Si Casting), alloy systems having solidus temperatures above the braze range (e.g., 3000 Series Wrought). In some embodiments, the high temperature solid solution material of the present disclosure can have a solidus temperature above 610 degrees Celsius, 620 degrees Celsius, 630 degrees Celsius, 640 degrees Celsius, 650 degrees Celsius, or 660 degrees Celsius. In other embodiments, the high conductivity parent material of the present disclosure can have a solidus temperature above 630 degrees Celsius, 640 degrees Celsius, or 650 degrees Celsius. In another aspect illustrated in FIG. 1, the alloy systems can have ranges of thermal conductivity properties.

One or more aspects of the present application correspond to a brazing parent material comprising a high melting point casting alloy that exhibits characteristics corresponding to excellent castability. More specifically, the brazing parent material is configured to be brazed with conventional brazing processes including, but not limited to vacuum brazing, controlled atmosphere brazing (CAB) brazing, and induction brazing, that are normally only able to be used on wrought aluminum alloy parent materials. In one aspect, the brazing parent material is illustratively characterized by a high solidus temperature relative to other brazing materials, including but not limited to Al—Si or Al—Mg brazing materials. In another aspect, the brazing parent material can be characterized based on thermal conductivity properties. In one aspect, the characterization of low or lower thermal conductivity can be based on thermal conductivity properties of 100 W/mK or lower. In some embodiments, the characterization of high or higher thermal conductivity can be based on thermal conductivity properties of about 160-220 W/mK. In another aspect, the characterization of high or higher thermal conductivity can be based on thermal conductivity properties of 170-200 W/mK. One skilled in the relevant art will appreciate that the ranges of thermal conductivity are illustrative in nature and do not represent all the possible characterizations of thermal conductivity or ranges of values satisfying thermal conductivity properties. For example, a characterization of low or lower thermal conductivity properties can be further characterized by various sub-ranges (e.g., 100-80 W/mK), threshold values or optimal values. In some embodiments, the low conductivity alloy of the present disclosure can have a thermal conductivity within a range of about 80-150 W/mK. In other embodiments, the low conductivity alloy of the present disclosure can have a thermal conductivity within a range of about 90-140 W/mK. Similarly, a characterization of high or higher thermal conductivity properties can be further characterized by various sub-ranges (e.g., 180-190 W/mK), threshold values or optimal values. Additionally, the brazing component can be further characterized by other attributes, such as minimal strength and the like.

Illustratively, for parent materials having high conductivity, the parent material can correspond to a compound of aluminum, 5.25% nickel, and additional impurities such as iron. Examples of high thermal conductivity parent materials are illustratively identified in FIG. 1. Such high conductivity parent materials in combination with the brazing material may be considered new applications.

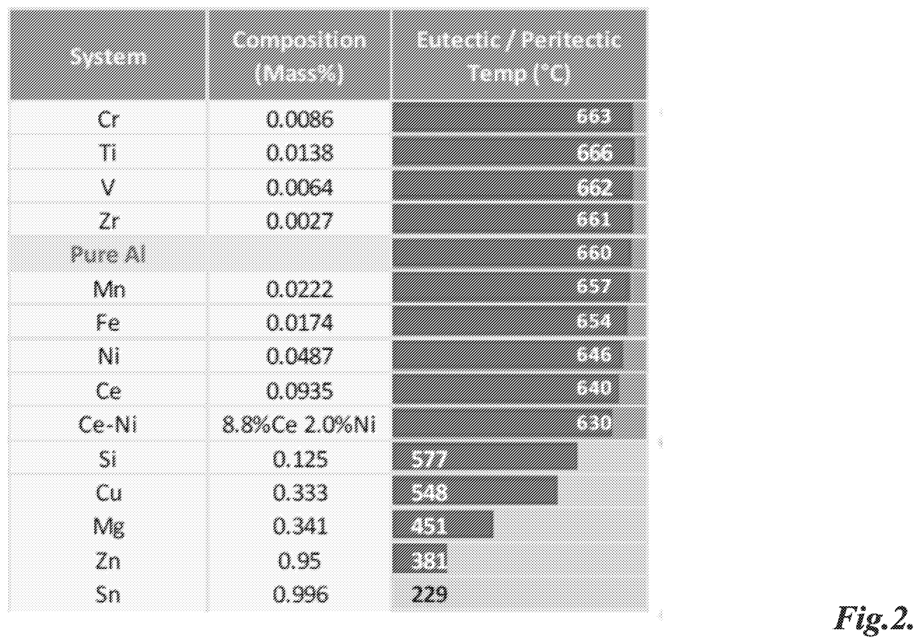

In another aspect, for parent materials of low thermal conductivity, the brazeable parent material can be made of Aluminum in combination at least one high temperature solid solution element based on the FCC α-Al matrix. Such low conductivity parent materials in combination with the brazing filler material may be considered new alloys. FIG. 2 illustrates suitable low conductivity parent materials having a eutectic/peritectic temperature above 600 degrees Celsius, which is a typical brazing temperature. Illustratively, the high temperature solid solution materials that can be included in the FCC α-Al matrix include Manganese, Chromium, Titanium, and Vanadium, Zirconium, Iron, Nickel, Cerium, Molybdenum, Silicon, Copper, Magnesium, Zinc or Tin, or combinations thereof. In some embodiments, the high temperature solid solution materials comprise Chromium of, of about, of at least, or at least about, 0.1 wt. %, 0.2 wt. % or 0.4 wt. %, or any range of values therebetween. In some embodiments, the high temperature solid solution materials comprise Titanium of, of about, of at least, or at least about, 0.01 wt. %, 0.2 wt. % or 1.3 wt. %, or any range of values therebetween. In some embodiments, the high temperature solid solution materials comprise Vanadium of, of about, of at least, or at least about, 0.01 wt. %, 0.1 wt. % or 0.65 wt. %, or any range of values therebetween. In some embodiments, the high temperature solid solution materials comprise Manganese of, of about, of at least, or at least about, 0.3 wt. %, 0.5 wt. % or 1 wt. %, or any range of values therebetween. In some embodiments, the high temperature solid solution materials comprise Iron of, of about, of at least, or at least about, 0.3 wt. %, 0.8 wt. % or 1.2 wt. %, or any range of values therebetween. In some embodiments, the high temperature solid solution materials comprise Nickel of, of about, of at least, or at least about, 1.5 wt. %, 3 wt. %, 4.5 wt. % or 6 wt. %, or any range of values therebetween. In some embodiments, the high temperature solid solution materials comprise Cerium of, of about, of at least, or at least about, 0.01 wt. %, 4 wt. % or 8.8 wt. %, or any range of values therebetween. In some embodiments, the high temperature solid solution materials comprise Magnesium of, of about, of at least, or at least about, 0.01 wt. %, 0.12 wt. % or 0.15 wt. %, or any range of values therebetween. In some embodiments, the high temperature solid solution materials comprise Zinc of, of about, of at least, or at least about, 0.01 wt. %, 0.85 wt. % or 1 wt. %, or any range of values therebetween. In some embodiments, the high temperature solid solution materials comprise Molybdenum of, of about, of at least, or at least about, 0.01 wt. %, 0.85 wt. % or 1 wt. %, or any range of values therebetween. In some embodiments, the high temperature solid solution materials are free or substantially free of Silicon, Copper, Magnesium, Zinc or Tin. In some embodiments, the high temperature solid solution materials can include elements which easily come out of super saturated solid solution. In some embodiments, the alloy composition can include elements which form dispersoids, for example, aluminum alloy 3003. Additionally, the brazeable alloy can include as much Iron as necessary to minimize die soldering. Table 1 illustrates the composition ranges for the solution materials.

TABLE 1
Composition (wt. %)

| Al | Balance |
|---|---|
| Ni | 0-5 |
| Ce | 0-10 |
| Fe | 0.5-1.2 |
| Mn | 0.5-3.0 |
| Cr | 0.1-0.6 |
| Ti | 0-0.2 |
| V | 0-0.2 |
| Zn | 0-1 |
| Mg | 0-0.2 |
| Zr | 0-0.3 |
| Si | <0.1 |
| Mo | 0-0.10 |

Some embodiments of the invention relate to casting aluminum alloys with both high yield strength and high thermal conductivity, as well as improved flowability and a resistance to hot tearing or cracking. The aluminum alloys were found to have high yield strength and high electrical conductivity compared to conventional, commercially available aluminum alloys. Other embodiments the invention relate to casting aluminum alloys with both high yield strength and low thermal conductivity, as well as improved flowability and a resistance to hot tearing or cracking. The aluminum alloys were also found to have high yield strength and high electrical conductivity compared to conventional, commercially available aluminum alloys. The aluminum alloys are described herein by the weight percent (wt. %) of the total elements and particles within the alloy, as well as specific properties of the alloys. It will be understood that the remaining composition of any alloy described herein is aluminum and incidental impurities.

Table 2 represents measured properties for the high pressure die castings that represent illustrative results of one or more aspects of the present application.

TABLE 2

| Name | AlNi₃FeMnCr_{0.4-1} |
|---|---|
| Nominal Composition (wt. %) | Al: Balance |
| | Ni: 3.0 |
| | Fe: 1.0 |
| | Mn: 1.0 |
| | Cr: 0.4 |
| Process | High pressure die cast |
| Condition | Post-Braze |
| Average Yield Strength (MPa) | 52.7 |
| Ultimate Tensile Strength (MPa) | 170 |
| Electrical Conductivity (% IACS) | 28.9 |

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed system, method, and computer program product. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure.

As used herein, the terms “comprises,” “comprising,” “includes,” “including,” “has,” “having” or any contextual variants thereof, are intended to cover a non-exclusive inclusion. For example, a process, product, article, or apparatus that comprises a list of elements is not necessarily limited to only those elements, but may include other elements not expressly listed or inherent to such process, product, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B is true (or present).

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, reversed, or otherwise controlled by another process.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

1. A high temperature solid solution material comprising:
Cr: 0.1 to 0.4 wt. %;
Mn: 0.3 to 1 wt. %;
Fe: 0.3 to 1.2 wt. %;
Ni: 1.5 to 6 wt. %;
the balance being aluminum and impurities.

2. The high temperature solid solution material of claim 1, further comprising Ti: 0.01 to 1.3 wt. %.

3. The high temperature solid solution material of claim 1, further comprising V: 0.01 to 0.65 wt. %.

4. The high temperature solid solution material of claim 1, further comprising Ce: 0.01 to 8.8 wt. %.

5. The high temperature solid solution material of claim 1, further comprising Mg: 0.01 to 0.15 wt. %.

6. The high temperature solid solution material of claim 1, further comprising Zn: 0.01 to 1 wt. %.

7. The high temperature solid solution material of claim 1, further comprising Mo: 0.01 to 1 wt. %.

8. The high temperature solid solution material of claim 1, wherein the high temperature solid solution material is free or substantially free of Silicon, Copper, Magnesium, Zinc or Tin.

9. A high conductivity parent material consisting essentially of:
Ni: 4.5 to 6 wt. %; and
the balance being aluminum and impurities.

10. The high conductivity parent material of claim 9, wherein Ni is 4.75 to 5.75 wt. %.

11. The high conductivity parent material of claim 10, wherein Ni is 5 to 5.5 wt. %.

12. The high conductivity parent material of claim 11, wherein Ni is 5.25 wt. %.

13. The high conductivity parent material of claim 9, wherein thermal conductivity is within a range of about 160-220 W/mK.

14. The high conductivity parent material of claim 13, wherein thermal conductivity is within a range of about 170-200 W/mK.

15. A low conductivity alloy comprising FCC α-Al matrix, wherein the solidus temperature of the alloy is above 610 degrees Celsius, and wherein the thermal conductivity is within a range of about 80-150 W/mK.

16. The low conductivity alloy of claim 15, wherein the solidus temperature of the alloy is above 630 degrees Celsius.

17. The low conductivity alloy of claim 15, wherein the thermal conductivity is within a range of about 90-140 W/mK.

18. The low conductivity alloy of claim 15, further comprising at least one at least one of Manganese, Chromium, Titanium, and Vanadium, Zirconium, Iron, Nickel, Cerium, or Molybdenum.

19. The low conductivity alloy of claim 15, wherein the alloy is free or substantially free of Silicon, Copper, Magnesium, Zinc or Tin.

20. The low conductivity alloy of claim 15, further comprising elements which form dispersoids.
